(19) United States
(12) Patent Application Publication
(10) Pub. No.: US 2021/0303441 A1
(43) Pub. Date: Sep. 30, 2021

(54) SYSTEMS AND METHODS FOR DYNAMICALLY LOGGING APPLICATION DATA

(71) Applicant: PAYPAL, INC., San Jose, CA (US)

(72) Inventors: Joydeep Hazra, Bangalore (IN); Rajendra Bhat, Bangalore (IN); Md Faiz Alam, Bangalore (IN); Sourav Kumar, Bihar (IN); Santosh Bharamasagar Chandrasekharappa, Bangalore (IN); Kaviya Rawat, New Delhi (IN)

(21) Appl. No.: 16/833,088

(22) Filed: Mar. 27, 2020

(51) Int. Cl. G06F 11/36

(52) U.S. Cl. CPC G06F 11/364; G06F 11/3612

(57) ABSTRACT

Methods and systems are presented for dynamically configuring a software application to log different data variables without requiring re-deploying the software application. When a software application is executed, the software application may obtain and/or generate data variables. During runtime of the software application while processing a request, the software application may access a log script external to the software application. The software application may select a subset of data variables for logging, and may record only the subset of data variables in a log file. The log script may be modified without requiring the software application to be modified or re-deployed such that the software application may log different subset of data variables while processing different processes based on different versions of the log script.

### BACKGROUND

The present specification generally relates to data logging for software applications, and more specifically, to dynamically and selectively logging various data associated with executing a software application according to various embodiments of the disclosure.

### RELATED ART

In order to track and/or diagnose the performance of a software application, data that is obtained and/or generated by the software application while running the software application may be logged for subsequent analysis. For example, specific programming code may be implemented within the software application, which causes the software application to record a particular set of data variables associated with the software application while the software application performs a process. Thus, each time the software application performs the process (e.g., to process a transaction) based on a request, the software application may log (e.g., store) the particular set of data variables, for example, in a log file. As the software application repeatedly performs the process based on different requests, the software application may continue to log the particular set of data variables pertaining to the processing of the different requests. The logged data may be analyzed for various purposes, such as to diagnose software issues (e.g. software bugs) associated with the software application, to perform trend analysis, to analyze incoming requests, etc.

However, logging software application data in such a manner has many drawbacks. For example, writing data to a log file (usually in a persistent memory such as a hard drive) consumes a substantial amount of time, which may lead to latency in processing the requests. Furthermore, since the instructions for selecting which variables to log are implemented within the programming code of the software application, it is difficult to change the selection of logged variables. Thus, there is a need for providing an efficient and flexible mechanism for logging software application data.

### BRIEF DESCRIPTION OF THE FIGURES

FIG. 1 is a block diagram illustrating an online service provider system according to an embodiment of the present disclosure;

FIG. 2 illustrates data logging by a software application in cooperation with a data logging module according to an embodiment of the present disclosure;

FIG. 3 is a block diagram illustrating a data logging module according to an embodiment of the present disclosure;

FIG. 4 is a flowchart showing a process of dynamically selecting data variables for logging according to an embodiment of the present disclosure;

FIG. 5 is a flowchart showing a process of dynamically modifying a selection of data variables for logging according to an embodiment of the present disclosure; and

FIG. 6 is a block diagram of a system for implementing a device according to an embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure describes methods and systems for dynamically configuring (and re-configuring) a software application to log different data variables without requiring re-deploying the software application. When a software application is executed (e.g., to perform a process), the software application may obtain (e.g., from input data) and/or generate data variables. The obtained and/or generated data variables are temporarily stored in a non-persistent memory space (e.g., random access memory, etc.) allocated on a machine for the execution of the software application. Since the data variables are stored in temporarily allocated memory space, these data variables are typically erased (no longer available) after the software application finishes performing the process (or after the software application is terminated from execution). As discussed above, software applications may often be configured to log various data variables by writing one or more of the data variables to a log file stored in a persistent data storage (e.g., a hard drive, a flash drive, etc.) such that the logged data can be accessed (e.g., viewed, analyzed, transmitted to other devices, etc.) for various purposes (e.g., diagnosis of the software application, tracking, etc.) after the software application is terminated or otherwise has finished performing the process.

Conventional ways to log data for a software application require specific instructions for logging data (e.g., instructions to write specific variables to a log file) to be implemented within the programming code of the software application. There are several drawbacks to this approach. First, it can be difficult to anticipate which data variables will be needed (e.g., for analysis and/or diagnosis of the software application) at the time the software application is developed. It is partly because different logged data variables may be required for different purposes and based on different circumstances. For example, a first set of data variables may be required to diagnose the performance of the software application while a second set of data variables may be required to analyze a trend of the requests. In another example, a third set of data variables may be required to determine if the software application has a first software defect while a fourth set of data variables may be required to determine if the software application has a second software defect. It is inefficient for a software application to log every possible data variable available to the software application as it detrimentally affects the performance of the software applications (e.g., it imposes substantial delays and latency for the software application in processing requests) and it causes the log files to be unnecessarily large in size. Once the software application is deployed (e.g., compiled and configured to run in a computing environment), any changes to the data logging logistics (e.g., selecting different variables for logging, selecting a different timing for writing the logged data to a log file, etc.) would require changes to the programming code of the software application and re-deploying the software application to the computing environment. The re-deploying of the software application may include incorporating changes to the programming code of the software application, compiling the software application, and updating the software application with the modified version in the production environment, which can be costly and risky, as it may introduce downtime (e.g., a period of time when the software application is unavailable for use) and new software defects (e.g., new software issues or defects to the software application that are introduced from the modification of the programming code).

Second, as the software application may include different modules for processing the requests, the instructions for logging data are likely implemented within the different modules of the software application. As the software application is executed to process a request according to a workflow, the data logging instructions may be executed during the processing of a request (e.g., in the middle of the workflow), which may cause unnecessary delay in the processing of the request as the software application is required to finish the logging of the data before moving on to other portions of the processing of the request.

Thus, according to various embodiments of the disclosure, a data logging system may provide a configurable data logging scheme for logging data for one or more software applications without requiring re-deploying of the software applications. In some embodiments, the data logging system may provide, for each of the one or more software applications, a log script external to the software application. Each log script may specify, for the corresponding software application, which data variables to log. In some embodiments, each of the log scripts may be implemented as a data file stored in a data storage that is accessible by the software application. The data logging system may also provide programming code to the software application, that when executed, would access the external log script and log data variables associated with the software application according to the log script. For example, the programming code may be encapsulated as a module within a software library that is incorporated within the software application.

In some embodiments, the data logging system may also provide a user interface that enables a user (e.g., a software developer, a tester, a product manager, etc.) to modify the selection of data variables associated with the software application for logging. In some embodiments, the data logging system may store, for each software application, a list of data variables available for logging. The list of data variables may be provided by software developer(s) who developed the software application (e.g., the software developer(s) may provide the list of data variables when the software application was initially deployed in the computing environment). For example, the software developer(s) may provide a log schema file to the data logging system. The log schema file may include information associated with all of the data variables available to be logged, which may include names of the data variables, possible values corresponding to the data variables, descriptions of the data variables, and other relevant information. In some embodiments, instead of having the list of available data variables provided by the software developer(s), the data logging system may access the programming code of the software application, parse the programming code, and derive the list of data variables available for logging based on the parsing. When the data logging system receives a request for modifying a selection of data variables to be logged for the software application, the data logging system may access the log script file associated with the software application to retrieve the list of data variables available to be logged by the software application, and provide the list of data variables on the user interface. The user may then select a subset of the data variables for logging via the user interface.

Based on the input received through the user interface, the data logging system may modify the log script associated with the software application. The modification to the log script may be performed after the software application has been deployed in the computing environment (e.g., a production environment) and without requiring the software application to be re-deployed. Thus, while processing a first request, the software application may be configured to log a first set of data variables based on a first log script. The data logging system may modify the log script to generate a second log script, for example, based on input received through the user interface subsequent to the software application processing the first request. After the log script is modified, the software application may be configured to log a second set of data variables while processing a second request based on the second log script. Using such an approach as disclosed herein, configuring (and re-configuring) the software application to log different data variables require only a modification to the log script (e.g., the data file that is external to the software application), which does not require any modifications to the software application itself. As such, software applications that have been deployed in a computing environment (e.g., a production environment) can be re-configured to log different data variables during different time periods dynamically without requiring the software applications to be re-deployed.

In some embodiments, based on the instructions provided by the data logging system, the software application may be configured to access the external log script and/or to log the set of data variables only after processing the request. For example, the instructions for accessing the log script and logging the set of data variables may be implemented at a location within the programming code of the software application after the instructions for processing the request, such that the software application does not log data until after the request is processed. In the event that a response is generated for the request, the software application may be configured to access the log script and/or to log the set of data variables only after generating the response and/or transmitting the response to the requesting device. This way, the processing of the request is not affected (e.g., delayed) by the logging of the data variables, which leads to improved performance of the software application in processing requests.

In some embodiments, in addition to specifying the set of data variables to be logged by the software application, the log script may also specify a format in which the set of data variables are recorded in a log file. The format may include one or more of: an order in which the set of data variables are recorded in the log file, names that are used to be associated with the set of data variables in the log file, spacing and/or other delimiters to separate the different data variables in the log file, and other formatting requirements. The format may be generated based on inputs received from a user via the user interface provided by the data logging system. Thus, the software application may be configured to log the set of data variables and in a format specified by the log script.

Just as the selection of the set of data variables for logging can be changed dynamically, the format for logging the data variables can by dynamically modified as well, without requiring the software application to be re-deployed. For example, the user interface provided by the data logging system may enable a user to modify the format in which the set of data variables are recorded in a log file. Based on the input(s) received via the user interface, the data logging system may modify the log script to implement the change of the format (and/or the selection of the data variables to be logged). Subsequent to the modification to the log script, the software application may access the modified log script to begin logging data variables according to the selection of data variables and format specified in the modified log script.

Since the data variables are logged in a format specified in the log script, the data logging system of some embodiments may determine a formatting of a log file associated with logged data variables from a software application by parsing the log script associated with the software application. The data logging system may then interpret the logged data based on the formatting and analyze the logged data. In some embodiments, the data logging system may derive a trend based on analyzing the logged data in one or more log files. For example, when the software application is an electronic payment processing application, the data logging system may analyze the logged data to derive a trend and/or an anomaly, such as an approval rate (when the outcome, which may be approved or denied, being a logged data variable) for a time period being higher or lower than an average by a threshold. In some embodiments, once the data logging system determines a trend and/or an anomaly from analyzing the data that was logged over a period of time, the data logging system may generate a report and may present the report on a device (e.g., a device associated with a payment service provider).

In some embodiments, once a trend and/or an anomaly is derived (e.g., the payment request denial rate for the past 3 months is higher than an average by more than a threshold), the data logging system may determine whether a correlation can be derived between the trend/anomaly and another logged data variable (e.g., an Internet Protocol (IP) address, a purchase amount, a purchase location, issuing bank of the payment card used in the purchase, a browser type of a browser used for the purchase, etc.). When a correlation is determined by the data logging system, the data logging system may include the correlated data variable(s) in the report.

If the data logging system cannot determine any correlation of the trend and/or the anomaly to another data variable, it is possibly because the data variable having a correlation with the trend and/or the anomaly is not a data variable selected for logging according to the current log script for the software application. As such, the data logging system may determine a particular data variable that is not selected for logging according to the log script, and may modify the log script to include the particular data variable for logging. After the log script is modified by the data logging system, the software application may begin logging data variables (including the particular data variable) when processing incoming requests according to the modified log script. The data logging system may allow the software application to process new incoming requests and log data according to the modified log script for a predetermined period of time (e.g., a day, a week, etc.) or for a predetermined number of requests (e.g., 100 requests, 1,000 requests, etc.) to generate new logged data that includes the particular data variable. The data logging system may then analyze the newly logged data to determine whether a correlation exists between the trend/anomaly and the particular data variable. If a correlation exists, the data logging system may present the correlation and the particular data variable on the device as a report. However, if a correlation does not exist, the data logging system may continue to determine another particular data variable that has not been selected for logging, modify the log script to include the other particular data variable for logging, and analyze the newly logged data to determine whether a correlation exists. The data logging system may continue to dynamically modify the log script to select different data variables (e.g., adding, removing, replacing, etc.) for logging while the software application is running to process incoming requests. In some embodiments, in addition to modifying the selection of data variables to be logged by the software application, the data logging system may also modify the format in which the data variables are logged in the log file. The software application is configured to log data according to the most updated version of the log script. Thus, the software application may be re-configured to log different sets of data variables during different time periods based on the different versions of the log script accessed by the software application at the time, without requiring the software application to be modified and/or re-deployed. As discussed above, the log script can be manually modified by a user via the user interface provided by the data logging system, or can be modified automatically by the data logging system based on past logged data.

In some embodiments, the log script may be generated by the data logging system to specify conditional logging of data variables. For example, the log script may be generated to specify to log a first data variable only when the software application satisfies a certain condition (e.g., when a second data variable is within a range of values, etc.). In some embodiments, the conditional logging may be implemented by using regular expression in the log script. Thus, when the software application executes the instructions for logging the data variables, the software application may first determine whether a value corresponding to the second data variable satisfies the certain condition, and logs the first variable (e.g., writing a value corresponding to the first variable to a log file) only when the value corresponding to the second variable satisfies the certain condition. Conditional logging reduces the amount of writing to the log file (in the persistent data storage), and thereby improving the speed of the software application in processing requests. The conditional logging of data variables can be implemented within the log script based on user inputs via the user interface or automatically performed by the data logging system based on analyzing historic logged data.

In some embodiments, the data logging system may also mask sensitive data while logging the data variables. It may be desirable that sensitive data, such as payment card identifiers, personal identification numbers (e.g., social security numbers), health information, and other data a user may not want publicly exposed or accessible by unauthorized parties, to be partially or fully redacted before they are stored in the log file in the persistent data storage. For example, the data logging system may determine that one or more data variables to be logged contains sensitive data, based on information associated with the one or more data variables provided in the log schema file or by analyzing the names and/or the values corresponding to the one or more data variables. In some embodiments, the data logging system may flag the one or more data variables in the log script once it is determined that the one or more data variables may include sensitive data. Thus, when the software application executes the instructions for accessing the log script and logging data, the software application may determine that the one or more data variables may contain sensitive data based on the flag, and may mask the sensitive data (e.g., fully or partially) before writing the one or more data variables in the log file. In some embodiments, the instructions provided in the software application for logging the data variables may include logic for detecting whether a data variable contains sensitive data or not. As the software application is logging each data variable, the logic may detect whether the data variable contains sensitive data. When it is detected that the data variable contains sensitive data, the instructions may cause the software application to mask the data variable (e.g., fully or partially) before writing the data variable to the log file in the persistent data storage.

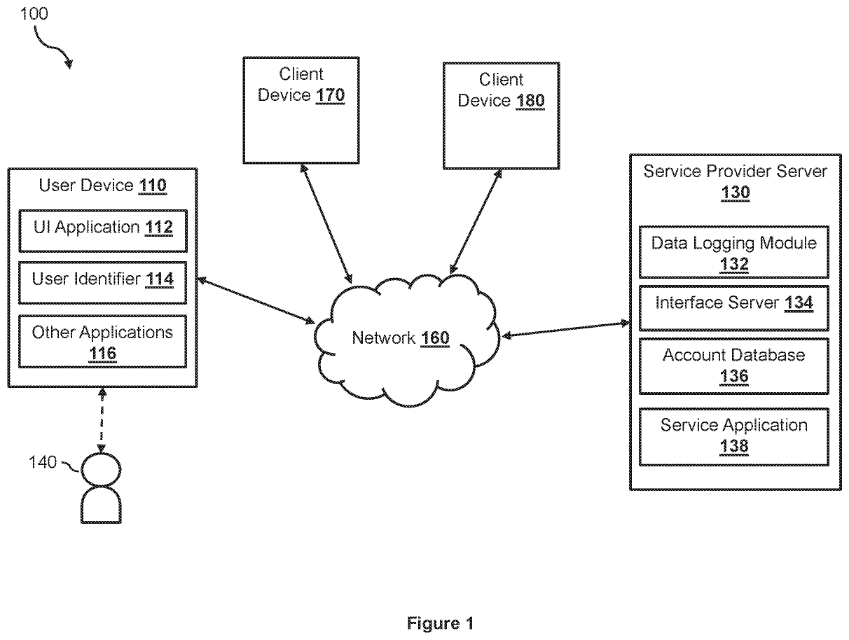

FIG. 1 illustrates a system 100, within which the data logging system may be implemented according to one embodiment of the disclosure. The system 100 includes a service provider server 130, and one or more client devices 110, 170, and 180 that may be communicatively coupled with each other via a network 160. The network 160, in one embodiment, may be implemented as a single network or a combination of multiple networks. For example, in various embodiments, the network 160 may include the Internet and/or one or more intranets, landline networks, wireless networks, and/or other appropriate types of communication networks. In another example, the network 160 may comprise a wireless telecommunications network (e.g., cellular phone network) adapted to communicate with other communication networks, such as the Internet.

Each of the user devices 110, 170, and 180 in one embodiment, may be utilized by their respective users to interact with the service provider server 130 over the network 160. For example, a user 140 may use the user device 110 to conduct online transactions with the service provider server 130 via a website hosted by a web server (e.g., a web server 134) associated with the service provider server 130. The user 140 may log in to a user account to access account services or conduct electronic transactions (e.g., account transfers or payments) with the service provider server 130. Each of the user devices 110, 170, and 180, in various embodiments, may be implemented using any appropriate combination of hardware and/or software configured for wired and/or wireless communication over the network 160. In various implementations, each of the user devices 110, 170, and 180 may include at least one of a wireless cellular phone, wearable computing device, PC, laptop, etc.

The user device 110, in one embodiment, includes a user interface application 112 (e.g., a web browser), which may be utilized by the user 140 to conduct electronic transactions (e.g., online payment transactions, etc.) and/or communicate with the service provider server 130 over the network 160. In one implementation, the user interface application 112 includes a proprietary software program (e.g., a mobile application) that provides a graphical user interface (GUI) for the user 140 to interface and communicate with the service provider server 130 via the network 160. In another implementation, the user interface application 112 includes a browser module that provides a network interface to browse information available over the network 160. For example, the user interface application 112 may be implemented, in part, as a web browser to view information available over the network 160.

The user device 110, in various embodiments, may include other applications 116 as may be desired in one or more embodiments of the present disclosure to provide additional features available to the user 140. In one example, such other applications 116 may include security applications for implementing client-side security features, programmatic client applications for interfacing with appropriate application programming interfaces (APIs) over the network 160, and/or various other types of generally known programs and/or software applications.

The user device 110, in one embodiment, may include at least one identifier 114, which may be implemented, for example, as operating system registry entries, cookies associated with the user interface application 112, identifiers associated with hardware of the user device 110 (e.g., a media control access (MAC) address), or various other appropriate identifiers. In various implementations, the identifier 114 may be passed with a user login request to the service provider server 130 via the network 160, and the identifier 114 may be used by the service provider server 130 to associate the user with a particular user account (e.g., and a particular profile) maintained by the service provider server 130.

In various implementations, the user 140 is able to input data and information into an input component (e.g., a keyboard) of the user device 110 to provide user information with a transaction request, such as a login request, a fund transfer request, a request for adding an additional funding source (e.g., a new credit card), or other types of request. The user information may include user identification information.

Each of the other user devices 170 and 180 may include hardware and modules similar to that of the user device 110 as described here. Even though only three user devices 110, 170, and 180 are shown in FIG. 1, it has been contemplated that more or less user devices (each similar to client device 110) may be communicatively coupled with the service provider server 130 via the network 160 within the system 100.

The service provider server 130, in one embodiment, may be maintained by an online service provider, which may provide online transaction services for the users of the user devices 110, 170, and 180. As such, the service provider server 130 may include a service application 138, which may be adapted to interact with the user device 110 over the network 160 to facilitate the searching, selection, purchase, payment of items, and/or other services offered by the service provider server 130. In one example, the service provider server 130 may be provided by PayPal®, Inc., of San Jose, Calif., USA, and/or one or more service entities or a respective intermediary that may provide multiple point of sale devices at various locations to facilitate transaction routings between merchants and, for example, service entities.

In some embodiments, the service application 138 may include a payment processing application for processing purchases and/or payments for electronic transactions between a user and a merchant or between any two entities. In one implementation, the payment processing application assists with resolving electronic transactions through validation, delivery, and settlement. As such, the payment processing application settles indebtedness between a user and a merchant, wherein accounts may be directly and/or automatically debited and/or credited of monetary funds in a manner as accepted by the banking industry.

The service provider server 130 may also include an interface server 134 that is configured to serve content (e.g., web content) to users and interact with users. For example, the interface server 134 may include a web server configured to serve web content (e.g., webpages) in response to HTTP requests. In another example, the interface server 134 may include an application server configured to interact with a corresponding application (e.g., a service provider mobile application) installed on the user device 110 via one or more protocols (e.g., RESTAPI, SOAP, etc.). As such, the interface server 134 may include pre-generated electronic content ready to be served to users. At least some of the pages (e.g., webpages) served to users are associated with electronic transactions. For example, the interface server 134 may store a log-in page (e.g., log-in webpage) and is configured to serve the log-in page to users for logging into user accounts of the users to access various service provided by the service provider server 130. The interface server 134 may also store a payment page (e.g., a payment webpage) and is configured to serve the payment page to users for conducting electronic payment transactions. As a result, a user may access a user account associated with the user and access various electronic services offered by the service provider server 130, by generating HTTP requests directed at the service provider server 130.

The service provider server 130 also includes a data logging module 132 that implements the data logging system as disclosed herein. The data logging module 132 may generate log scripts for one or more software applications associated with the service provider server 130, such as the service application 138, the interface server 134, and possibly other applications. In some embodiments, the data logging module 132 may also provide instructions to be implemented within each of the software applications, for example, as a module within a library that can be incorporated by the software applications. The instructions may cause each of the software applications, when running, to log data variables specified in the corresponding log script and in a format specified in the corresponding log script. For example, each of the software applications may record data variables according to the log script in a log file stored in a persistent data storage of the service provider server 130. In some embodiments, the data logging module 132 may also provide a user interface that enables a user associated with the service provider server 130 to select a subset of data variables for logging by a software application, to modify the subset of data variables for logging by the software application, and to specify a format for logging the subset of data variables by the software application. In some embodiments, the data logging module 132 may analyze the data that is logged by a software application and may dynamically modify the log script based on the analyzing the logged data. The modification to the log script causes the corresponding software application to begin logging different data variables and/or logging data variables in a different format, without requiring the software application to be re-deployed.

The service provider server 130, in one embodiment, may be configured to maintain one or more user accounts and merchant accounts in an account database 136, each of which may be associated with a profile and may include account information associated with one or more individual users (e.g., the user 140 associated with user device 110). For example, account information may include private financial information of users, such as one or more account numbers, passwords, credit card information, banking information, digital wallets used, or other types of financial information, transaction history, Internet Protocol (IP) addresses, device information associated with the user account. In certain embodiments, account information also includes user purchase profile information such as account funding options and payment options associated with the user, payment information, receipts, and other information collected in response to completed funding and/or payment transactions.

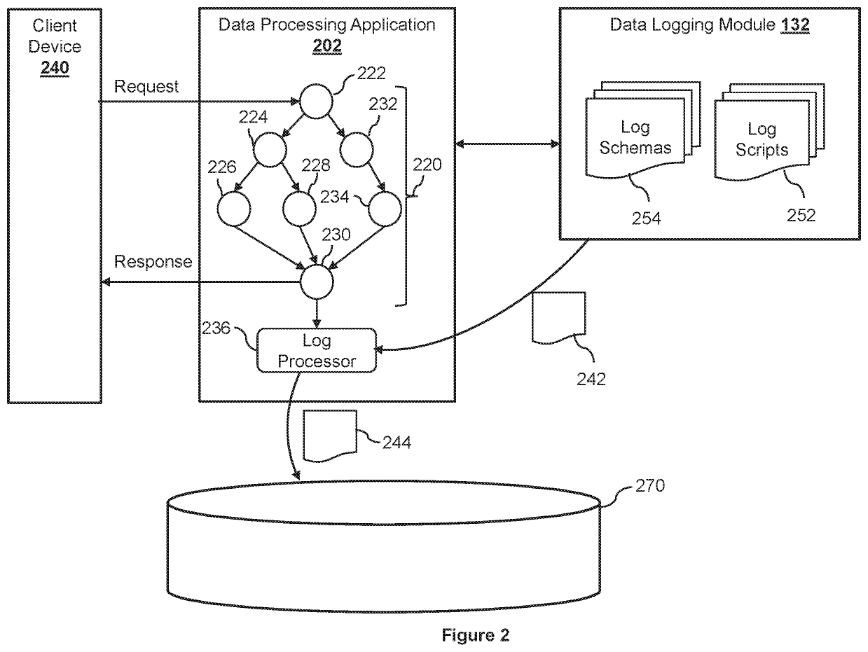

FIG. 2 illustrates data logging by a software application in cooperation with the data logging module 132 according to an embodiment of the disclosure. In FIG. 2, a data processing application 202 is shown to be configured to perform a process based on requests received from client devices, such as a client device 240. In some embodiments, the data processing application 202 may be any one of the software applications associated with the service provider server 130, such as the service application 138, the interface server 134, or other applications associated with the service provider server 130. The client device 240 may be an external device such as one of the user devices 110, 170, and 180. The client device 240 may also be an internal device associated with the service provider server 130 that requires services provided by the data processing application 202. In some embodiments, the client device 240 may submit a request (e.g., a request to process a transaction such as an electronic payment transaction) to the data processing application 202. The request may include input data, such as data related to the electronic payment transaction (e.g., an identification of a payor account with the service provider server 130, an identification of a payee account with the service provider server 130, a payment amount, etc.).

In response to receiving the request, the data processing application 202 may initiate a workflow for processing the request. In some embodiments, a workflow is a processing flow that the data processing application 202 may follow for processing a request (or a transaction). The workflow may include multiple sub-processes. In some embodiments, when processing a request (or a transaction), the data processing application 202 may perform all or only a subset of the sub-processes. For example, the workflow may include branches associated with one or more conditions for branching out to different paths in the workflow. When the data processing application 202 reaches a branch in the workflow, the data processing application 202 may determine to follow one or another path in the workflow based on whether the one or more conditions are satisfied. FIG. 2 illustrates an example workflow 220 that may be initiated by the data processing application 202 for processing the request from the client device 240. As shown, the workflow 220 may include multiple nodes 222-234, each of which is associated with a sub-process for the data processing application 202 in the workflow 220. The data processing application 202 may use a subset of the nodes (following a path) to process the request, based at least in part on the data included in the request. For example, the node 222 may be associated with a condition of whether a payment amount of the request is over $500. Thus, the data processing application 202 may process the request by following the path including the nodes 222, 224, 226, and 230 when the request is associated with a payment amount over $500, and may process the request by following the path including the nodes 222, 232, 234, and 230 when the request is associated with a payment amount below $500. In some embodiments, the data processing application 202 may be configured to generate a response based on the request (e.g., an approval, a denial, etc.) in the node 230 (which may be the last node in the workflow 220), and may transmit the response to the client device 240. In some embodiments, the workflow 220 is completed once the response is transmitted to the client device 240.

The data processing application 202 may obtain and/or generate data corresponding to various data variables while performing the workflow 220. Using the example of an electronic payment transaction request, at the node 222 where the data processing application 202 receives the request from the client device 240, the data processing application 202 may obtain data from the request itself, such as an identification of a payor account with the service provider server 130, an identification of a payee account with the service provider server 130, and a payment amount. While performing one or more sub-processes associated with the other nodes in the workflow 220, the data processing application 202 may obtain additional data from the client device 240 for processing the request, such as an Internet Protocol (IP) address associated with the client device 240, a device identifier (e.g., a media access control (MAC) address) of the client device 240, browser data associated with a browser application used by the client device 240 to submit the request, a geographical location of the client device 240, authentication credentials, and other data associated with the request. In addition, while performing one or more sub-processes in the workflow 220, the data processing application 202 may also obtain data from other modules or devices associated with the service provider server 130 to process the request. For example, the data processing application 202 may query the account database 136 using the identifier of the payor and obtain payment card and/or bank information, a transaction history, transaction restriction data, etc. Furthermore, the data processing application 202 may generate additional data based on the obtained data. For example, the data processing application 202 may generate an average payment amount associated with the payor within a predetermined time period (e.g., last 3 months, etc.), a risk score for the request based on the IP address, transaction amount, the location of the client device 240, and the average payment amount, and other data, while processing the sub-processes associated with any one of the nodes 222-230.

When the data processing application 202 obtains and/or generates the data variables, the data processing application 202 may temporarily store the data variables in a non-persistent memory space of a machine (e.g., a computer server) allocated to the data processing application 202 (e.g., the random access memory (RAM) of the machine running the data processing application 202). The storing of the data variables in the non-persistent memory space is temporary because the data variables may become unavailable, such as when the data processing application 202 is terminated, when the machine running the data processing application 202 is powered down, or when the data processing application 202 cleans the memory space (e.g., deleting the data variables) after processing the request. In some embodiments, to conserve memory usage, the data processing application 202 may erase the data variables from the non-persistent memory space or otherwise make the non-persistent memory space that stores the data variables available for use by the data processing application 202 (e.g., for processing subsequent requests) or other applications. It is a common practice for a software application to log at least some of the data variables for various purposes, such as to diagnose the performance of the software application, to track the processing of the requests, etc. Logging the data variables includes writing the data variables to a persistent data storage (e.g., copying the data variables from the non-persistent memory space to the persistent data storage), such as to a data file that is stored in a persistent data storage (e.g., a hard drive, flash drive, etc.) so that the data variables can be accessed (e.g., viewed, analyzed, transmitted, etc.) by the software application, a human operator, or other applications such as an analytic tool after the request is processed.

Conventionally, at least some of the nodes 222-234 may include instructions for logging data variables when the node is being executed by the data processing application 202 (e.g., logging the data variables as they are obtained and/or generated). However, as discussed above, such an approach for logging data variables at different stages (different nodes) in the workflow is inefficient. For example, since it is inefficient and wasteful of resources to log all variables obtained and/or generated by the data processing application, implementing the data logging process within the nodes requires the software developer(s) of the data processing application 202 to determine, in advance when the data processing application 202 is being developed and before the data processing application 202 is deployed in a production environment, which data variables to log. If it is determined, after the data processing application 202 is deployed to the production environment, that other data variables are needed for analysis, the programming code of the data processing application 202 needs to be modified, the modified data processing application 202 needs to be re-compiled and re-deployed in the production environment, which may cause downtime to the data processing application 202 and may introduce errors (e.g., software bugs) into the data processing application 202. Furthermore, logging the data variables while processing the request delays the processing of the request.

Thus, according to some embodiments of the disclosure, the data processing application 202 may not log any data variables while performing the workflow 220. Instead, the data logging module 132 may provide instructions (e.g., the log processor 236) to the data processing application 202 that cause the data processing application 202 to log data associated with processing the request outside of the workflow, for example, after the workflow is completed (e.g., after the data processing application 202 finishes processing the sub-process associated with the node 230).

In some embodiments, the log processor 236 may include programming instructions that is encapsulated within a module of a software library, that may be incorporated by the data processing application 202. The data processing application 202 may trigger (e.g., execute) the log processor 236 after the workflow 220 is completed. When the log processor 236 is triggered, the log processor 236 may log one or more of the data variables obtained and/or generated by the data processing application 202 while processing the request. In some embodiments, instead of hardcoding which data variables are to be logged within the programming instructions associated with the log processor 236 and/or the data processing application 202, the data processor 236 may be configured to dynamically select one or more data variables from the data variables obtained and/or generated by the data processing application 202 based on one or more log scripts that is stored external to (but are accessible by) the data processing application 202.

As shown in FIG. 2, the data logging module 132 includes one or more log schemas 254 and one or more log scripts 252, which may be stored as data files in the same machine as the machine running the data processing application 202 or in another machine communicatively coupled to the machine running the data processing application 202. The log scripts 252 may include different log scripts, each associated with a different software application. For example, the log scripts 252 may include a log script 242 associated with the data processing application 202, and other log scripts that are associated with other software applications. Each log script may specify, for a corresponding software application, which data variables to log. For example, if the data processing application 202 obtained and/or generated 100 different data variables while processing the request, the log script 242 may specify only a subset of the 100 data variables (e.g., 10, 20, 30, etc.) for logging. The log processor 236 may access the log script 242 every time it is triggered (e.g., every time the data processing application 202 processes a request and completes the workflow). Thus, the log processor 236 may dynamically select which data variables to log based on the log script 242 every time it is triggered by the data processing application 202. The log processor 236 may log the selected data variables by copying the selected variables from the non-persistent memory space to a log file 244 and storing the log file 244 in a persistent data storage 270. Furthermore, since the log processor 236 can be triggered after the workflow 220 is completed (and a response transmitted to the client device 240), the logging of data variables no longer slows down the process of the request.

In some embodiments, in addition to specifying data variables to be logged by the data processing application 202, the log script 242 may also specify a format in which the data variables are recorded in the log file 244. The format may include one or more of: an order in which the set of data variables are recorded in the log file, names that are used to be associated with the set of data variables in the log file, spacing and/or other delimiters to separate the different data variables in the log file, and other formatting requirements. Thus, the log processor 236, when triggered, may log the selected data variables in the log file 244 according to the format specified in the log script 242. Since the data variables are logged in a format specified in the log script 242, the data logging module 132 (or another data analytic module) of some embodiments may determine a formatting of a log file (e.g., the log file 244) associated with logged data variables from the data processing application 202 by parsing the log script 242 associated with the data processing application 202. The data logging module 132 (or another data analytic module) may then interpret the logged data based on the formatting and analyze the logged data.

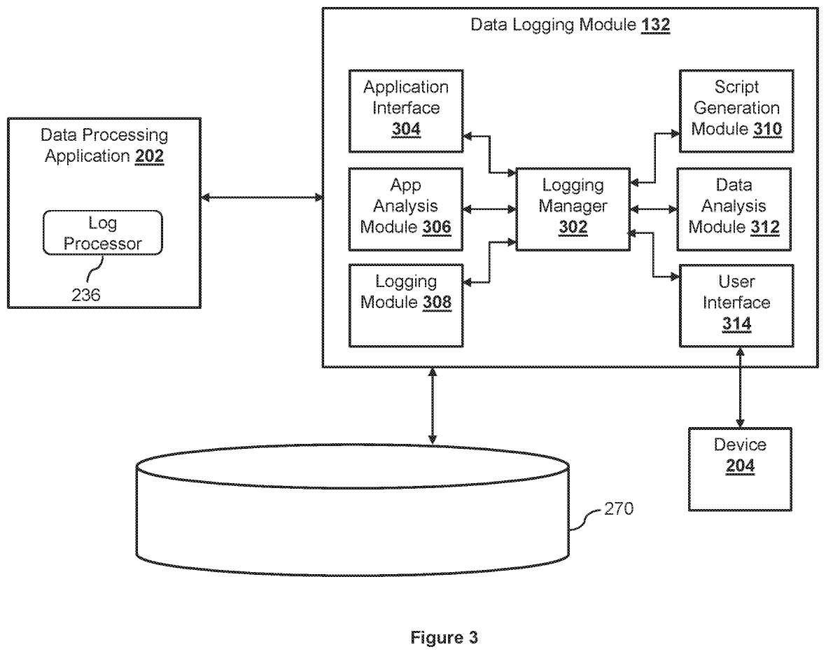

FIG. 3 illustrates the data logging module 132 according to one embodiment of the disclosure. The data logging module 132, in some embodiments, includes a logging manager 302, an application interface 304, an application monitoring module 306, a logging module 308, a script generation module 310, a data analysis module 312, and a user interface 314. The application interface 304 may provide an interface to different software applications (e.g., the data processing application 202) for performing the data logging process, such as by executing the log processor 236. The logging module 308 may be implemented, in part or in whole, within the log processor 236 for logging data variables associated with software applications, such as the data processing application 202. As such, the logging module 308 may access a log script (e.g., the log script 242) associated with a software application (e.g., the data processing application 202) to select which data variables to log for the software application, and log the selected data variables for the software application in a log file (e.g., the log file 244). The log scripts are external to the software applications, and are external to the log processor 236. Thus, the log processor 236 that is implemented within the software applications may be generic without including any information associated with the software applications and which data variables for logging (thus, the same log processors 236 can be incorporated into different software applications). Since the log scripts (e.g., the log script 242) are external to the software applications (e.g., the data processing application 202), the selection of data variables for logging may be modified without modifying the software applications and without re-deploying the software applications.

In some embodiments, the data logging module 132 may provide the user interface 314 to devices associated with the service provider server 130, such as a device 204, that enables a user (e.g., a software developer, a tester, a product manager, etc.) associated with the service provider server 130 to modify the selection of data variables associated with the software applications for logging. In some embodiments, whenever a software application is developed (or modified), the data logging module 132 may be provided a list of data variables that are available for logging (e.g., the data variables that are obtained and/or generated by the software application while processing requests). For example, the software developer(s) of the software application may provide a log schema file to the data logging system. The log schema file may include information associated with all of the data variables available to be logged, which may include names of the data variables, possible values corresponding to the data variables, descriptions of the data variables, and other relevant information. In some embodiments, instead of being provided by the software developer(s), the application analysis module 306 of the data logging module 132 may access the programming code of the software application, parse the programming code, and derive the list of data variables available for logging based on the parsing. Thus, the data logging module 132 may store a set of log schema files 254, each for a different software application. When the user interface 314 of the data logging module 132 receives a request for modifying (or generating) a selection of data variables to be logged for the data processing application 202, the data logging manager 302 may access a log schema file associated with the data processing application 202 to retrieve the list of data variables available to be logged by the data processing application 202, and provide the list of data variables on the user interface 314. The user may then select a subset of the data variables for logging via the user interface 314. Furthermore, the user may also configure a format related to how the data variables are written in the log file 244 via the user interface 314.

Based on the input received through the user interface 314, the script generation module 310 may generate or modify the log script 242 associated with the data processing application 202. The generation or modification to the log script 242 may be performed after the data processing application 202 has been deployed in the computing environment (e.g., a production environment) and without requiring the data processing application 202 to be re-deployed. The script generation module 310 may generate or modify the log script 242 to specify the selection of data variables to logged and the format in which the data variables are logged based on the input. The data processing application 202 (and the logging processor 236) may then log data variables according to the log script 242 when processing requests.

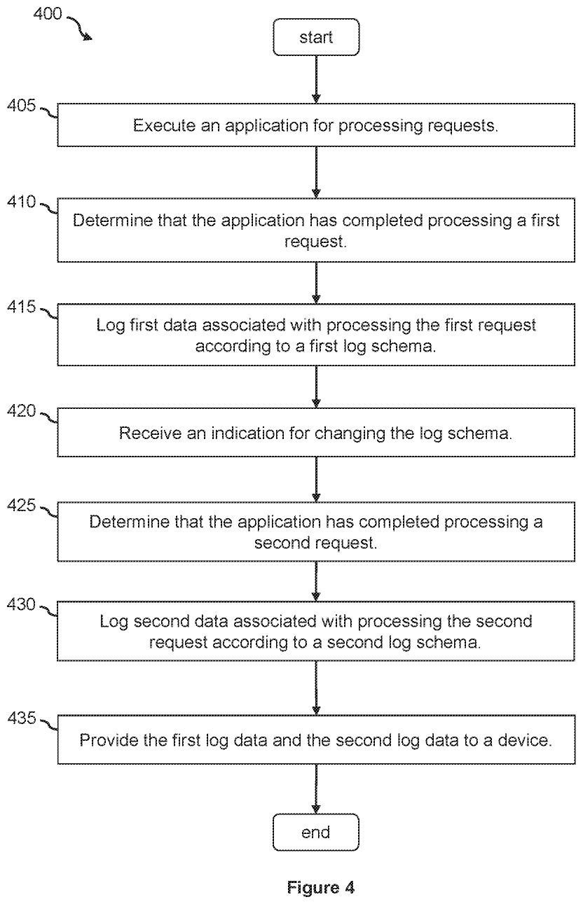

FIG. 4 illustrates a process 400 for logging data variables according to one embodiment of the disclosure. The process 400 may be performed, at least in part, by the data logging module 132 and a software application, such as the data processing application 202. The process 400 begins by executing (at step 405) an application for processing requests. For example, the data processing application 202 may be executed to process requests submitted by client devices, such as the client device 240. As the data processing application 202 processes a request (e.g., a first request) submitted by the client device 240, the data processing application 202 may initiate the workflow 220 and perform subprocesses associated with at least some of the nodes 222-230 of the workflow 220.

The process 400 determines (at step 410) that the application has completed processing a first request and logs (at step 415) first data associated with processing the first request according to a first log script. For example, the data processing application 202 may continue to perform subprocesses associated with the nodes of the workflow 220. As the data processing application 202 performs the subprocesses associated with the nodes, the data processing application 202 may obtain and/or generate data variables for processing the first request. Using the example of processing an electronic payment transaction request, the data processing application 202 may obtain data variables such as a payment amount, a payor identifier, and/or a payee identifier from the first request itself. The data processing application 202 may obtain other data variables from the client device 240 for processing the first request, such as a device identifier, a network address (e.g., an IP address), a location of the client device 240, a browser type, etc. The data processing application 202 may also obtain and/or generate additional data for processing the request, such as an average amount of payment from the payor, a risk score of the payor, the response generated for the request, etc. When the data processing application 202 obtains or generates the data variables, the data processing application 202 may store the data variables in a non-persistent memory space as key-value pairs, such as by assigning data values to different data variable names (e.g., amount=$500, payor_ID=1435, risk_score=80, avg_payment=$200, IP_add=236.33.22.12, response=approved, etc.).

After the data processing application 202 performs the sub-process associated with the node 230 (e.g., generating and transmitting a response to the client device 240), the data processing application 202 may determine that the processing of the request is completed, and may initiate the log processor 236 (e.g., by calling application programming interface (API) calls associated with the data logging module 132). The log processor 236 may access the log script 242 associated with the data processing application 202, and select at least a subset of the data variables obtained and/or generated by the data processing application 202 based on the log script 242. For example, the log script 242 may specify the data variable names of the data variables selected for logging. The log processor 236 may then retrieve the selected data variables from the non-persistent memory based on the log script 242, and log the data variables. In some embodiments, the log processor 236 may write the data variables (e.g., the data values associated with the data variables) to a log file 244.

In some embodiments, the log script 242 may specify conditional logging of data variables. For example, the log script 242 may specify to log a first data variable (e.g., an IP address of the client device) only when a second data variable satisfies a requirement (e.g., the location of the client device is within a particular region, the amount of payment is over a threshold amount, etc.). In some embodiments, the conditional logging may be implemented by using regular expression in the log script 242. Thus, when the data processing application 202 (or the log processor 236 that is implemented within the data processing application 202) executes the instructions for logging the data variables, the data processing application 202 may first determine whether a value corresponding to the second data variable satisfies the certain requirement, and logs the first variable (e.g., writing a value corresponding to the first variable to the log file 244) only when the value corresponding to the second variable satisfies the certain requirement. Conditional logging reduces the amount of writing to the log file (in the persistent data storage), and thereby improving the speed of the software application in processing requests.

In some embodiments, the logging module 308 may also mask sensitive data while logging the data variables. It may be desirable that sensitive data, such as payment card identifiers, personal identification numbers (e.g., social security numbers), health information, banking information, account information, and passwords, to be partially or fully redacted before they are stored in the persistent data storage. For example, the logging module 308 may determine that one or more data variables to be logged contains sensitive data, based on information associated with the one or more data variables provided in the log schema file 254 or by analyzing the names and/or the values corresponding to the one or more data variables. In some embodiments, the logging module 308 may flag the one or more data variables in the log script 242 once it is determined that the one or more data variables may include sensitive data. Thus, when the data processing application executes the instructions for accessing the log script and logging data, the software application may determine that the one or more data variables may contain sensitive data based on the flag, and may mask the sensitive data (e.g., fully or partially) before writing the one or more data variables in the log file 244. In some embodiments, the instructions provided in the data processing application 202 (e.g., the log processor 236) for logging the data variables may include logic for detecting whether a data variable contains sensitive data or not. As the data processing application 202 is logging each data variable, the logic may detect whether the data variable contains sensitive data. When it is detected that the data variable contains sensitive data, the instructions may cause the software application to mask the data variable (e.g., fully or partially) before writing the data variable to the log file in the persistent data storage.

The log file 244 may be an existing log file associated with the data processing application 202 and stored in the persistent data storage 270. As such, the log file 244 may store logged data associated with processing different requests (e.g., previous requests) by the data processing application 202. Each time the data processing application 202 processes a new request, the log processor 236 adds new logged data to the log file 244. In some embodiments, the log processor 236 may create a new data log file 244 for the data processing application (e.g., when such log file associated with the data processing application 202 does not exist).

In some embodiments, the log script 242 may also specify a format for logging the selected data variables. For example, the log script 242 may specify one or more of: an order in which the set of data variables are recorded in the log file 244, names that are used to be associated with the set of data variables in the log file, spacing and/or other delimiters (e.g., a carriage return, a semi-colon, etc.) to separate the different data variables in the log file, and other formatting requirements. Thus, the log processor 236 may log the selected data variables in the log file 244 according to the log script 242. In one example, based on the log script 242, the log processor 236 may select the payor identifier, the payee identifier, the amount, the IP address of the client device 240 for logging. The log script 242 may specify that the names associated with the data values that are recorded in the log file 244 to be different from the data variable names used by the data processing application 202. For example, the log script 242 may specify to use the name “Payor ID” for the data variable name “payor_ID”, use the name “Payee ID for the data variable name “payee_ID”, use the name “Payment Amount” for the data variable name “amount”, use the name “IP Address” and use the name “Response” for the data variable name “response”. The log script 242 may also specify that the different data variables are separated by semi-colons. Thus, based on the log script 242, the log processor 236 may generate the log file 244 to include “Payor ID=1435; Payee ID=2123; Payment Amount=$500; IP Address=236.33.22.12; Response=Approved”.

After the first data associated with processing the first request is logged, the process 400 may receive (at step 420) an indication for changing the log script. As discussed herein, the data logging module 132 may modify one or more log scripts associated with software applications without re-deploying the software applications. The log scripts may be modified automatically or based on user inputs. In some embodiments, the log scripts may be modified based on user input received by the data logging module 132 via the user interface 314. For example, a human operator may determine that a different subset of data variables associated with the data processing application 202 should be logged (e.g., based on analyzing previously recorded log data in the log file 244) and may use the device 204 to change the log script 242. Thus, the data logging module 132 may receive an indication, from the device 204 via the user interface 314, for changing the log script 242. Upon receiving the indication, the data logging module 132 may access a log schema file associated with the data processing application 202. The log schema file may include information related to all of the data variables associated with the data processing application 202 available for logging, which may include names of the data variables, possible values corresponding to the data variables, descriptions of the data variables, and other relevant information. In some embodiments, the software developer(s) of the data processing application 202 may provide the log schema file to the data logging 132 when the data processing application 202 is developed and/or deployed. In some embodiments, instead of being provided by the software developer(s), the application analysis module 306 of the data logging module 132 may access the programming code of the software application, parse the programming code, and derive the list of data variables available for logging based on the parsing. Based on the input received through the user interface 314, the script generation module 310 may modify the log script 242 associated with the data processing application 202. For example, the script generation module 310 may specify a different subset of data variables for logging (e.g., the payor ID, the payee ID, the payment amount, location of the client device, and the response to the request). In some embodiments, the script generation module 310 may also specify a different format for logging the data variables.

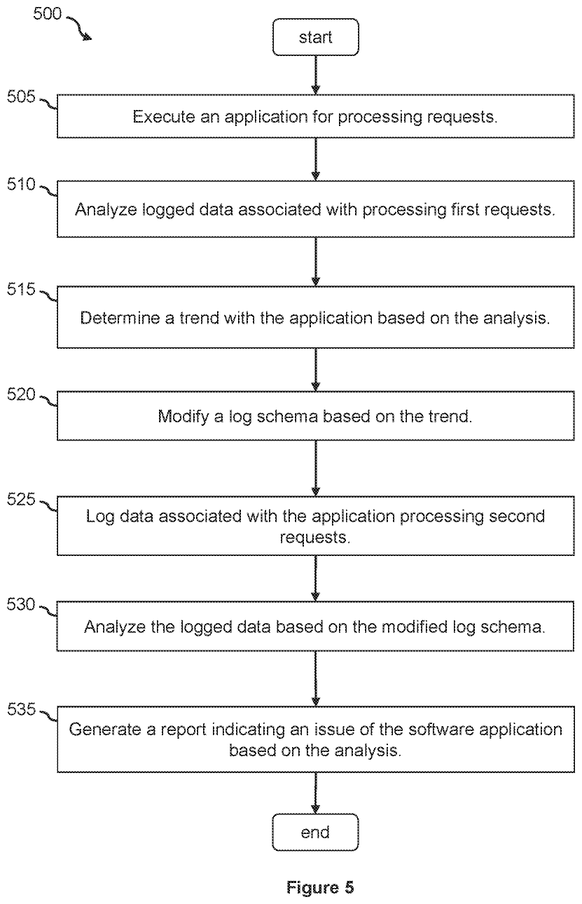

Instead of modifying the log script 242 based on user inputs, the data logging module 132 may generate and/or modify the log script 242 automatically based on analyzing previously logged data associated with the data processing application 202. The process of automatically generating and/or modifying a log script will be described in more detail below by reference to FIG. 5.

The process 400 then determines (at step 425) that the application has completed processing a second request and logs (at step 430) second data associated with processing the second request according to a second log script. For example, subsequent to modifying the log script 242, the data processing application 202 may receive another request (e.g., a second request) from a client device (the client device 240 or another device). The data processing application 202 may perform the workflow 220 for the second request and may obtain and/or generate data variables associated with performing the second request (e.g., a payor identifier, a payee identifier, an amount, a risk score of the payor, a location of the client device, a response to the request, an IP address associated with the client device, etc.). The values of the data variables associated with processing the second request are likely to be different from the values of the same data variables associated with processing the first request (e.g., a different payor, a different amount, etc.). After the data processing application 202 finishes processing the subprocess associated with the node 230 of the workflow 220, the data processing application 202 may initiate the log processor 236 to log data for the processing of the second request. The log processor 236 may access the modified log script 242 associated with the data processing application 202 and may log the data variables according to the modified log script 242. Based on the modification of the log script 242, the log processors may log different data variables for the processing of the second request than the data variables logged for the processing of the first request. For example, the log processor 236 may log the payor ID, the payee ID, the payment amount, a response to the request, and the location of the client device (instead of the IP address of the client device) for the second request based on the modified log script 242. In some embodiments, the log processor 236 may write the data variables to the log file 244 (e.g., add the data variables to the log file 244) or may write the data variables to a new log file based on the modification of the log script 242.

At step 435, the process 400 provides the first log data and the second log data to a device. For example, a human operator associated with the service provider server 130 may use a device, such as the device 204, to request to view logged data associated with the data processing application 202 via the user interface 314. The data analysis module 312 may retrieve the log file 244 and/or additional log file(s) associated with the data processing application 202 from the data storage 270, and may present the logged data stored in the log file(s) on the device 204. In some embodiments, the data analysis module 312 may additionally analyze the logged data from the log file(s) and present a report that may include a summary, a trend, or other statistical data generated based on analyzing the logged data on the device 204.

FIG. 5 illustrates a process 500 for automatically modifying a log script according to one embodiment of the disclosure. In some embodiments, the process 500 may be performed by the data logging module 132 and/or the data processing application 202. The process 500 begins by executing (at step 505) an application for processing requests. For example, the data processing application 202 may be executed to process requests submitted by client devices, such as the client device 240. As the data processing application 202 processes one or more requests submitted by client devices, the data processing application 202 may log data variables associated with processing the requests based on the log script 242. In some embodiments, the data processing application 202 may store the logged data in the log file 244.

The process 500 then analyzes (at step 510) logged data associated with processing first requests and determine (at step 515) a trend with the application based on the analysis. For example, the data processing application 202 may process a first set of requests during a first period of time (e.g., a day, a week, a month, etc.) and log data variables associated with processing the first set of requests in the log file 244. The data analysis module 312 may analyze the logged data from the log file 244 to determine a trend and/or an anomaly associated with processing the first set of requests. For example, by analyzing the logged data, the data analysis module 312 may determine that a request denial rate for requests submitted in the past 2 weeks has exceeded an average rate by a threshold (e.g., by 30%). In another example, by analyzing the logged data, the data analysis module 312 may determine that the number of requests submitted by a range of IP addresses has exceeded an average submission rate by another threshold.

In some embodiments, once a trend and/or an anomaly is detected (e.g., the payment request denial rate for the past 3 months is higher than average by more than a threshold), the data analysis module 312 may determine whether a correlation can be derived between the trend/anomaly and one or more the data variables. For example, when the log script 242 specifies logging of the IP addresses, the data analysis module 312 may determine whether a correlation, within a predetermined threshold, exists between the anomaly (e.g., the rise in request denial rate) and the IP address of the devices submitting the requests. When a correlation is determined by the data analysis module 312, the data analysis module 312 may include the correlated data variable(s) in a report, and may present the report to a device associated with the service provider server 130, such as the device 204.

If the data analysis module 312 cannot determine any correlation or a correlation below a predetermined threshold between the trend and/or the anomaly and another logged data variable, it is possibly because the data variable having a correlation with the trend and/or the anomaly is not a data variable selected for logging based on the log script 242. As such, the data analysis module 312 may determine a particular data variable (e.g., locations of client devices that submitted the requests) that is not one of the selected data variable for logging according to the log script 242, and may modify the log script 242 to include the particular data variable for logging. Accordingly, the process 500 modifies (at step 520) a log script based on the trend. For example, based on analyzing the logged data and the trend, the script generation module 310 may modify the log script 242 by adding the particular data variable to the set of selected data variable for logging, or by replacing an existing data variable specified by the log script 242 with the particular data variable to keep the number of logged data variables low. In some embodiments, to reduce the amount of data being logged, the script generation module 310 may implement conditional logging in the log script 242. For example, if the data analysis module 312 determines a first correlation between the trend/anomaly and a first variable (e.g., amount over $500), the data analysis module 312 may determine whether a second correlation between the trend/anomaly exists and a second variable (e.g., a location of the client device). Thus, the script generation module 310 may modify the log script to specify that the location of the client device be logged only when the amount is over $500.

The process 500 then logs (at step 525) data associated with the application processing second requests. For example, after the log script 242 has been modified by the script generation module 310, the data processing application 202 may begin logging data variables (including the particular data variable such as the locations of the client devices) when processing incoming requests according to the modified log script 242. The process 500 then analyzes (at step 530) the logged data based on the modified log script and generates (at step 535) a report indicating an issue of the software application based on the analysis. For example, the data logging module 132 may allow the data processing application 202 to process new incoming requests and log data according to the modified log script 242 for a predetermined period of time (e.g., a day, a week, etc.) or for a predetermined number of requests (e.g., 100 requests, 1,000 requests, etc.) to generate new logged data that includes the particular data variable. The data analyzing module 312 may then analyze the newly logged data (that includes the particular data variable) to determine whether a correlation exists between the trend/anomaly and the particular data variable.

If the data analysis module 312 determines that a correlation exists between the trend/anomaly and the particular data variable (e.g., the high request denial rate corresponds to requests submitted from client devices located within a particular geographical region, such as Brazil), the data logging module 132 may present the correlation and the particular data variable on the device (e.g., the device 204) as a report.

However, if the data analysis module 312 cannot determine a correlation between the trend/anomaly and the particular data variable, the data logging module 132 may continue to determine another particular data variable that has not been selected for logging, modify the log script 242 to include the other particular data variable for logging, and analyze the newly logged data to determine whether a correlation exists. The data logging module 132 may continue to dynamically modify the log script to select different data variables (e.g., adding, removing, replacing, etc.) for logging (and the data processing application 202 may continuously log different selected data variables while processing different requests) without modifying and/or re-deploying the data processing application 202 such that no interruption of the data processing application 202 processing incoming requests is created based on the modification of the selection of logged data variables. Thus, the data processing application 202 may be re-configured to log different sets of data variables during different time periods based on the different versions of the log script 242 at the time of processing the requests. As illustrated herein, the log script 242 can be modified based on user input received from a user via the user interface 314 or automatically by the data logging system based on analyzing of past logged data.

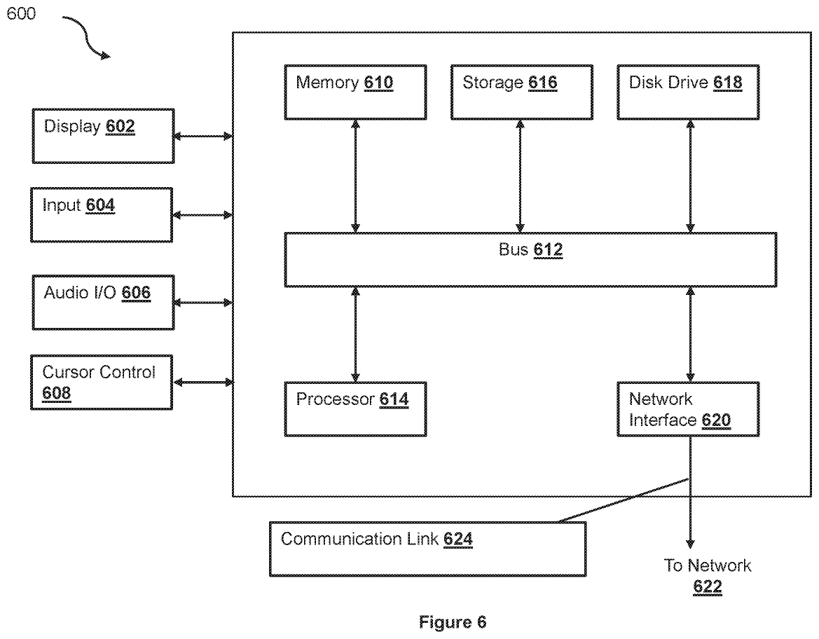

FIG. 6 is a block diagram of a computer system 600 suitable for implementing one or more embodiments of the present disclosure, including the service provider server 130 and the client devices 110, 170, and 180. In various implementations, each of the client devices 110, 170, and 180 may include a mobile cellular phone, personal computer (PC), laptop, wearable computing device, etc. adapted for wireless communication, and the service provider server 130 may include a network computing device, such as a server. Thus, it should be appreciated that the devices 110, 130, 170, and 180 may be implemented as the computer system 600 in a manner as follows.

The computer system 600 includes a bus 612 or other communication mechanism for communicating information data, signals, and information between various components of the computer system 600. The components include an input/output (I/O) component 604 that processes a user (i.e., sender, recipient, service provider) action, such as selecting keys from a keypad/keyboard, selecting one or more buttons or links, etc., and sends a corresponding signal to the bus 612. The I/O component 604 may also include an output component, such as a display 602 and a cursor control 608 (such as a keyboard, keypad, mouse, etc.). The display 602 may be configured to present a login page for logging into a user account or a checkout page for purchasing an item from a merchant. An optional audio input/output component 606 may also be included to allow a user to use voice for inputting information by converting audio signals. The audio I/O component 606 may allow the user to hear audio. A transceiver or network interface 620 transmits and receives signals between the computer system 600 and other devices, such as another user device, a merchant server, or a service provider server via network 622. In one embodiment, the transmission is wireless, although other transmission mediums and methods may also be suitable. A processor 614, which can be a micro-controller, digital signal processor (DSP), or other processing component, processes these various signals, such as for display on the computer system 600 or transmission to other devices via a communication link 624. The processor 614 may also control transmission of information, such as cookies or IP addresses, to other devices.

The components of the computer system 600 also include a system memory component 610 (e.g., RAM), a static storage component 616 (e.g., ROM), and/or a disk drive 618 (e.g., a solid-state drive, a hard drive). The computer system 600 performs specific operations by the processor 614 and other components by executing one or more sequences of instructions contained in the system memory component 610. For example, the processor 614 can perform dynamic logging of application data described herein according to the processes 400 and 500.

Logic may be encoded in a computer readable medium, which may refer to any medium that participates in providing instructions to the processor 614 for execution. Such a medium may take many forms, including but not limited to, non-volatile media, volatile media, and transmission media. In various implementations, non-volatile media includes optical or magnetic disks, volatile media includes dynamic memory, such as the system memory component 610, and transmission media includes coaxial cables, copper wire, and fiber optics, including wires that comprise the bus 612. In one embodiment, the logic is encoded in non-transitory computer readable medium. In one example, transmission media may take the form of acoustic or light waves, such as those generated during radio wave, optical, and infrared data communications.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by the computer system 600. In various other embodiments of the present disclosure, a plurality of computer systems 600 coupled by the communication link 624 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The various features and steps described herein may be implemented as systems comprising one or more memories storing various information described herein and one or more processors coupled to the one or more memories and a network, wherein the one or more processors are operable to perform steps as described herein, as non-transitory machine-readable medium comprising a plurality of machine-readable instructions which, when executed by one or more processors, are adapted to cause the one or more processors to perform a method comprising steps described herein, and methods performed by one or more devices, such as a hardware processor, user device, server, and other devices described herein.

What is claimed is:

1. A system, comprising:
a non-transitory memory; and
one or more hardware processors coupled with the non-transitory memory and configured to read instructions from the non-transitory memory to cause the system to perform operations comprising:
determining that a software application running on a device has reached a particular state within a workflow for processing a request;
in response to determining that the software application has reached the particular state within the workflow, accessing a log script external to the software application;
selecting, from a set of data variables used or generated by the software application during the workflow, a subset of data variables based on the log script; and
writing the subset of data variables to a log file according to a format specified in the log script.

2. The system of claim 1, wherein the particular state represents a completion progress of the workflow.

3. The system of claim 1, wherein the software application is configured to produce a response based on the request, and wherein the subset of data variables is written to the log file after the software application has produced the response.

4. The system of claim 1, wherein the set of data variables corresponds to a set of data variable types, wherein the operations further comprise:
providing, on a user device, a user interface for configuring the log script;
presenting, on the user interface, the set of data variable types;
receiving a selection of a subset of data variable types; and
generating the log script based on the selection.

5. The system of claim 1, wherein the operations further comprise:
determining that the software application has reached the particular state within the workflow for processing a second request;
in response to determining that the software application has reached the particular state within the workflow for processing the second request, accessing a second log script external to the software application;
selecting, from the set of data variables, a second subset of data variables based on the second log script; and
writing the second subset of data variables to a second log file according to a second format specified in the second log script.

6. The system of claim 1, wherein the operations further comprise:
obtaining a plurality of log files including the log file from running the software application for processing a plurality of requests;
analyzing log data in the plurality of log files based on the format specified in the log script; and
generating a report indicating an issue with the software application based on the analyzing the log data.

7. The system of claim 1, wherein the operations further comprise:
determining a trend based on responses generated by the software application in response to processing a plurality of requests;
while the software application is running, automatically selecting, from a set of data variable types associated with the software application, a subset of data variable types based on the trend; and
generating the log script based on the selecting the subset of data variable types.

8. The system of claim 1, wherein the operations further comprise:
modifying the log script while the software application is running, wherein the subset of data variables is selected based on the modified log script, wherein the log script is modified without re-deploying the software application.

9. A method, comprising:
executing, by one or more hardware processors, a software application for processing incoming requests;
determining, from a set of data variable types associated with the software application, a first subset of data variable types based on a first log script;
generating a first log file based on first data used or generated by the software application from processing a first request, wherein the first data corresponds to the first subset of data variable types;
subsequent to generating the first log file and while the software application is running, receiving an indication for changing log data;
in response to receiving the indication, determining, from the set of data variable types, a second subset of data variable types based on a second log script; and
generating a second log file based on second log data used or generated by the software application from processing a second request, wherein the second data corresponds to the second subset of data variable types.

10. The method of claim 9, further comprising:
analyzing the first log file;
selecting, from the set of data variable types, the second subset of data variable types for logging based on the analyzing the first log file; and
generating the second log script based on the selecting.

11. The method of claim 9, further comprising:
analyzing the second log file; and
determining a software defect associated with the software application based on the analyzing the second log file.

12. The method of claim 9, further comprising:
determining a condition associated with logging a first data variable of the second subset of data variables;
determining whether the condition is satisfied while processing the second request; and
in response to determining that the condition is satisfied, recording a first value corresponding to the first data variable in the second log file.

13. The method of claim 12, wherein the determining whether the condition is satisfied comprises determining whether a value corresponding to a second variable of the set of data variable is within a predetermined value range.

14. The method of claim 9, further comprising:
determining that a first data variable of the second subset of data variables is associated with a first type of data; and
modifying at least a first value corresponding to the first data variable before writing the first value to the second log file.

15. The method of claim 14, wherein the modifying comprises redacting at least a portion of the first value.

16. A non-transitory machine-readable medium having stored thereon machine-readable instructions executable to cause a machine to perform operations comprising:
receiving a request by an application running on the machine from a user device;
generating, by the application, values corresponding to a set of variables while processing the request, wherein the values are stored in a non-persistent memory of the machine;
determining, by the application, a response for the request;
subsequent to transmitting the response to the user device, accessing a log script stored external to the application;
determining, from the set of variables, a subset of variables for logging based on the log script;
retrieving a subset of the values corresponding to the subset of variables from the non-persistent memory; and
recording the subset of the values in a log file stored in a persistent data storage.

17. The non-transitory machine-readable medium of claim 16, wherein the log script is a first log script, and wherein the operations further comprise:
generating, by the application, second values corresponding to the set of variables while processing a second request;
accessing a second log script different from the first log script;
determining, from the set of variables, a second subset of variables for logging based on the second log script;
retrieving a subset of the second values corresponding to the second subset of variables from the non-persistent memory; and
recording the subset of the second values in a log file stored in a persistent data storage.

18. The non-transitory machine-readable medium of claim 16, wherein the determining the subset of variables for logging based on the log script comprises:
determining a condition associated with logging a first variable based on the log script;
determining whether the condition is satisfied; and
in response to determining that the condition is satisfied, including the first variable in the subset of variables.

19. The non-transitory machine-readable medium of claim 18, wherein the determining whether the condition is satisfied comprises determining whether a value corresponding to a second variable is within a particular value range.

20. The non-transitory machine-readable medium of claim 16, wherein the operations further comprise:
determining that a first value corresponding to a first variable of the subset of variables comprises a first type of data;
in response to the determining that the first value comprises the first type of data, modifying the first value by redacting at least a portion of the first value; and
recording the modified first value, and not the first value, in the log file.
